(19) United States
(12) Patent Application Publication
(10) Pub. No.: US 2016/0114502 A1
(43) Pub. Date: Apr. 28, 2016

(54) METHOD OF MANUFACTURING MOLD AND METHOD OF MANUFACTURING POLARIZER

(71) Applicant: Samsung Display Co., Ltd., Yongin-city (KR)

(72) Inventors: Kang-Soo HAN, Seoul (KR); Jung-Gun NAM, Suwon-si (KR); Moon-Jung AN, Hwaseong-si (KR); Dae-Young LEE, Seoul (KR); Dae-Hwan JANG, Seoul (KR); Gug-Rae JO, Asan-si (KR)

(21) Appl. No.: 14/712,619

(22) Filed: May 14, 2015

(30) Foreign Application Priority Data
Oct. 24, 2014 (KR) 10-2014-0145384

(51) Int. Cl. B29C 33/38; G02B 1/08; G02B 5/30

(52) U.S. Cl. CPC B29C 33/3828; G02B 5/3058; G02B 1/08; B29C 33/3857; B29K 2909/08; B29K 2905/00; B29K 2901/12; B29L 2011/00

(57) ABSTRACT

Provided are a method of manufacturing a mold, a method of manufacturing a polarizer, and a display apparatus including the polarizer. According to one or more exemplary embodiments, a method of manufacturing a mold, the method including: forming a polymer pattern on a substrate, the polymer pattern including protrusions; forming a wire grid template portion on the substrate by etching, the substrate being etched using protrusions of the polymer pattern as a mask; forming a cover mask covering a portion of the wire grid template portion; forming a recess in the substrate by etching, the substrate being etched using the cover mask, the recess having a bottom surface lower than an upper surface of the wire grid template portion; and removing the cover mask.

### CROSS-REFERENCE TO RELATED APPLICATION

This application claims priority from and the benefit under 35 U.S.C.§119(a) of Korean Patent Application No. 10-2014-0145384, filed on Oct. 24, 2014, which is incorporated by reference as if fully set forth herein.

### BACKGROUND

1. Field

Exemplary embodiments relate to a method of manufacturing a mold, to a method of manufacturing a polarizer, and more particularly, to a method of manufacturing a mold for use with a method of manufacturing a polarizer for a liquid crystal display apparatus.

2. Description

A liquid crystal display apparatus applies a voltage to a liquid crystal layer to change arrangement of the liquid crystal layer. Accordingly, visible optical properties, such as birefringence, optical rotation, dichroism, light scattering or the like, are changed to display an image.

A liquid crystal display apparatus generally includes a polarizer to control light transmittance. The polarizer may transmit a polarization component parallel to a transmitting axis, and may block a polarization component perpendicular to the transmitting axis. The polarizer may absorb some of light from a light source, and thus, light efficiency of the liquid crystal display apparatus may decrease undesirably.

Further, when a wire grid pattern is included in a polarizer for the liquid crystal display apparatus, external light, including components in the ultraviolet range, can be relatively easily transmitted into the liquid crystal display apparatus, damaging the liquid crystal.

The above information disclosed in this Background section is only for enhancement of understanding of the background of the inventive concept, and, therefore, it may contain information that does not form the prior art that is already known in this country to a person of ordinary skill in the art.

### SUMMARY

One or more exemplary embodiments provide a method of manufacturing a mold.

One or more exemplary embodiments provide a polarizer which is formed by using the mold.

One or more exemplary embodiments provide a method of manufacturing the polarizer.

Additional aspects will be set forth in the detailed description which follows, and, in part, will be apparent from the disclosure, or may be learned by practice of the inventive concept.

One or more exemplary embodiments provide a method of manufacturing a mold, the method including: forming a polymer pattern on a substrate, the polymer pattern including protrusions; forming a wire grid template portion on the substrate by etching, the substrate being etched using protrusions of the polymer pattern as a mask; forming a cover mask covering a portion of the wire grid template portion; forming a recess in the substrate by etching, the substrate being etched using the cover mask, the recess having a bottom surface lower than an upper surface of the wire grid template portion; and removing the cover mask.

One or more exemplary embodiments provide a method of manufacturing a mold, the method including: forming a polymer pattern on a substrate, the polymer pattern including protrusions; forming a wire grid template portion on the substrate by etching the substrate, the substrate being etched by using the protrusions of the polymer pattern as a mask; forming a cover mask covering a portion of the wire grid template portion; forming a polymer layer on exposed portions of the wire grid template portion and the cover mask; applying pressure on the polymer layer; and separating the polymer layer from the substrate, the separated polymer layer including a recess portion and a linear pattern portion. The recess portion has a bottom surface lower than an upper surface of the linear pattern portion. The recess portion is formed corresponding to the cover mask, and the linear pattern portion is formed corresponding to the exposed portions of the wire grid template portion.

One or more exemplary embodiments provide a method of manufacturing a polarizer and a reflection portion, including: disposing a metal layer on a substrate; disposing a polymer layer on the metal layer; forming a transferred pattern on the polymer layer based on a mold, the transferred pattern including a grid portion and a reflection portion, the grid portion including protrusion portions, the reflection portion having a width greater than a width of a protrusion portion; and forming linear patterns and a reflection portion by etching the metal layer, the metal layer being etched using the transferred pattern as a mask, the linear patterns and the reflection portion being disposed on a same layer.

According to one or more exemplary embodiments, a polarizer including a plurality of linear patterns and a reflection portion disposed on a same layer as the linear pattern may be formed by a mold at the same time, thereby reducing manufacturing cost, manufacturing processes, and time.

According to one or more exemplary embodiments, a reflection portion of the polarizer including a flat surface of a reflection portion, which directly contacts a flat surface of a base substrate on which the linear patterns and reflection portion are formed may reflect light more effectively.

According to one or more exemplary embodiments, a polarizer includes a pattern which corresponds to a black matrix disposed in a peripheral area. The peripheral area is on which an image is not displayed. Thus, light efficiency from the backlight unit may be improved.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a cross-sectional view illustrating a polarizer, according to one or more exemplary embodiments.

FIG. 2A, 2B, 2C, 2D, 2E, and FIG. 2F are cross-sectional views for describing a method of manufacturing a mold for forming a polarizer of FIG. 1, according to one or more exemplary embodiments.

FIG. 3A, 3B, 3C, 3D, 3E, 3F, 3G, and FIG. 3H are cross-sectional views for describing a method of manufacturing a mold for forming a polarizer of FIG. 1, according to one or more exemplary embodiments.

FIG. 4A, 4B, 4C, 4D, and FIG. 4E are cross-sectional views for describing a method of manufacturing a polarizer of FIG. 1, according to one or more exemplary embodiments.

FIG. 5 is a cross-sectional view illustrating a display panel, according to one or more exemplary embodiments.

FIG. 6 is a cross-sectional view taken along a line I-I′ of FIG. 5, according to one or more exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one . . . selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

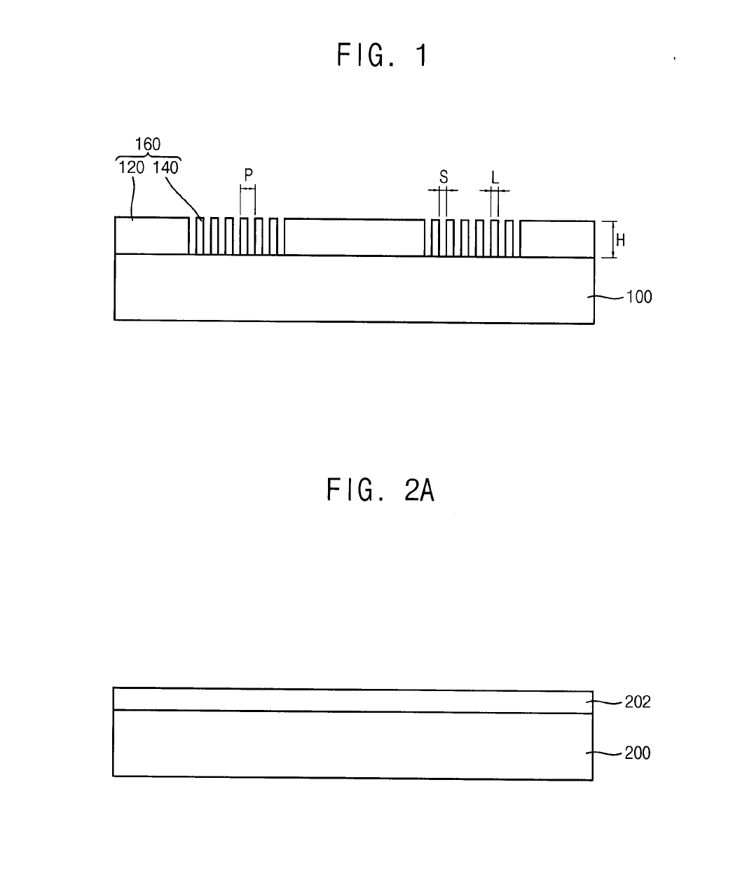

FIG. 1 is a cross-sectional view illustrating a polarizer, according to one or more exemplary embodiments.

Referring to FIG. 1, the polarizer includes substrate 100 and metal layer 160.

Substrate 100 may include a material which has relatively high transmittance, thermal stability, and chemical compatibility. For example, substrate 100 may include at least one material selected from the group of glass, polyethylenenaphthalate, polyethylene terephthalate and polyacryl.

Metal layer 160 may be disposed on substrate 100. Metal layer 160 may include a plurality of linear pattern portions 140 and reflection portions 120. Linear pattern portions 140 may have a width spanning adjacent reflection portions 120. Linear pattern portions 140 and reflection portions 120 may be disposed on a same layer.

Metal layer 160 may include at least one material selected from the group of aluminum (Al), gold (Au), silver (Ag), copper (Cu), chrome (Cr), iron (Fe), and nickel (Ni). Also, for example, metal layer 160 may include a first sublayer and a second sublayer disposed on the first sublayer. The first sublayer may include at least one material selected from the group of aluminum (Al), gold (Au), silver (Ag), copper (Cu), chrome (Cr), iron (Fe), and nickel (Ni). The second sublayer may include molybdenum or titanium.

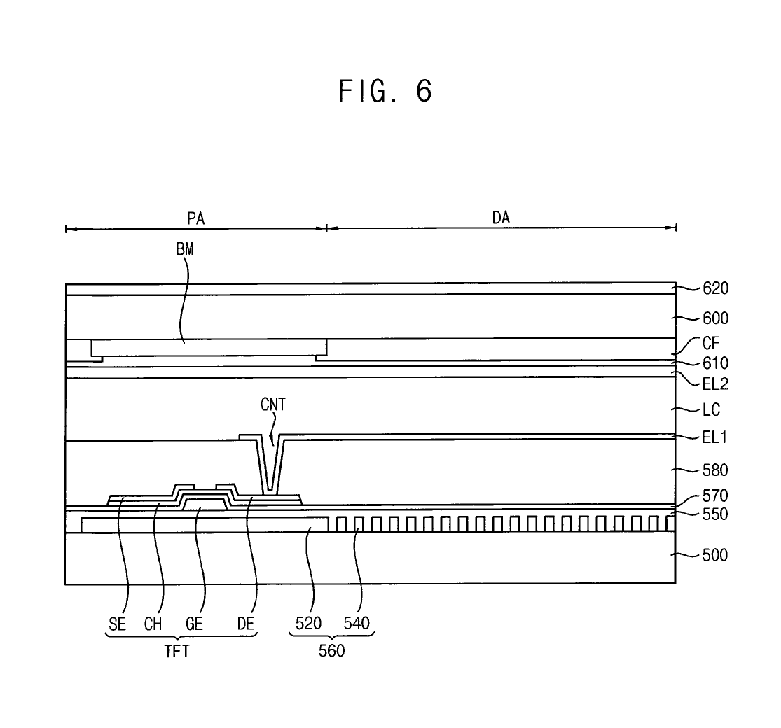

Metal layer 160 may include the plurality of linear pattern portions 140, through which light passes, and reflection portions 120, which block light. More detailed description about the polarizer of one or more exemplary embodiments will be described with respect to FIG. 6.

Linear pattern portions 140 may have a line width L, a separation distance S and a pitch P. The pitch P is a sum of the line width L and the separation distance S. Adjacent two linear patterns may be spaced apart from each other by the separation distance S. In some exemplary embodiments, an air gap can exist between adjacent linear pattern portions 140 instead of, or in addition to, reflection portions 120.

Light may pass through air gaps between the linear patterns in linear pattern portions 140. The separation distance S may be smaller than a wavelength of incident light to polarize the incident light. For example, for incident visible light of the wavelength of about 400 nm to about 700 nm, the separation distance S may be smaller than about 400 nm.

For example, the pitch P of the linear pattern 140 may be about 50 nm to about 100 nm. A height H of the linear pattern 140, which corresponds to the distance between an upper surface of the substrate 100 and an upper surface of the linear pattern 140, may be about 50 nm to about 300 nm.

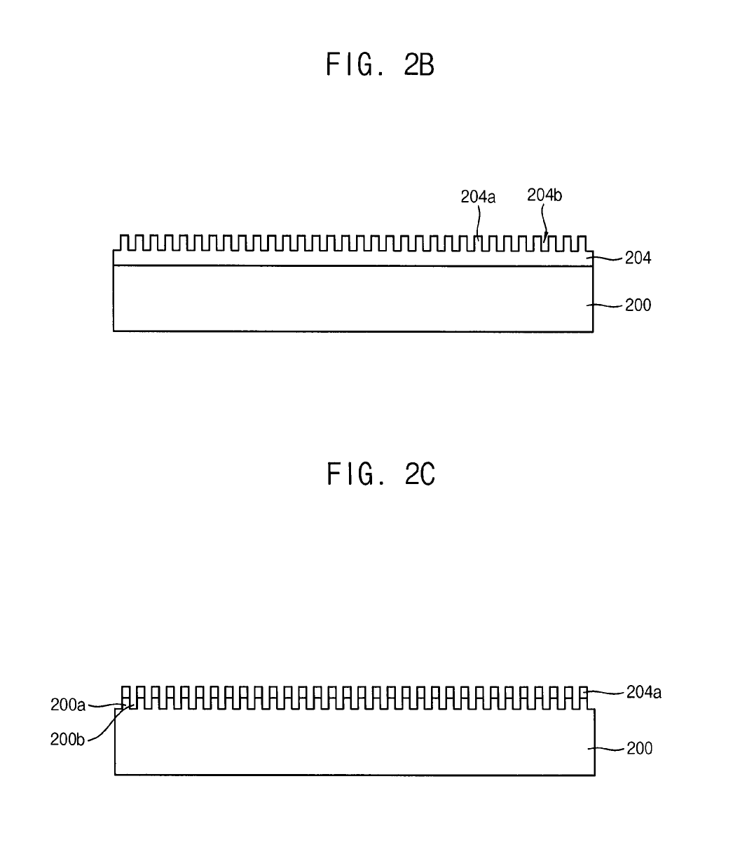

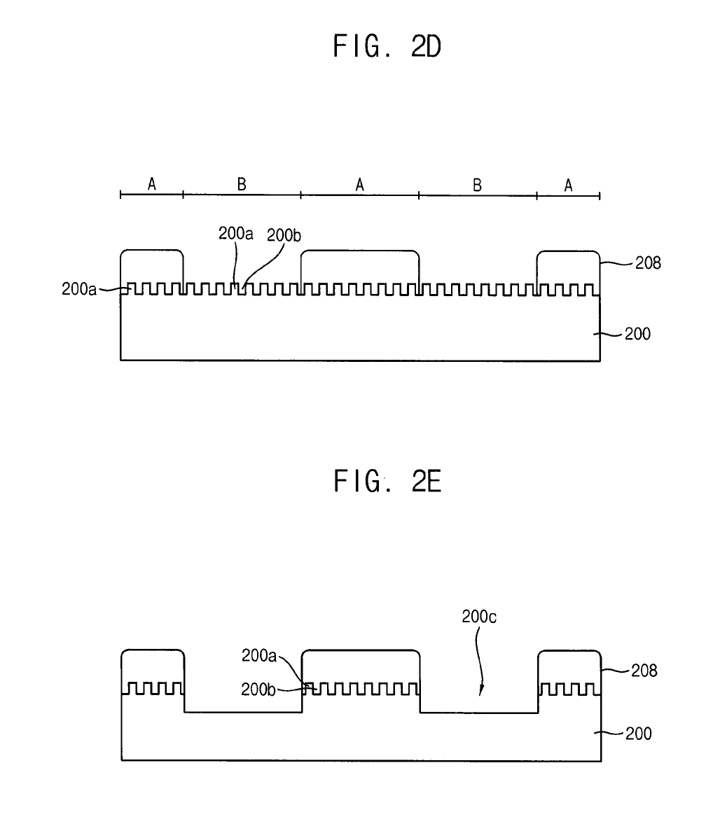

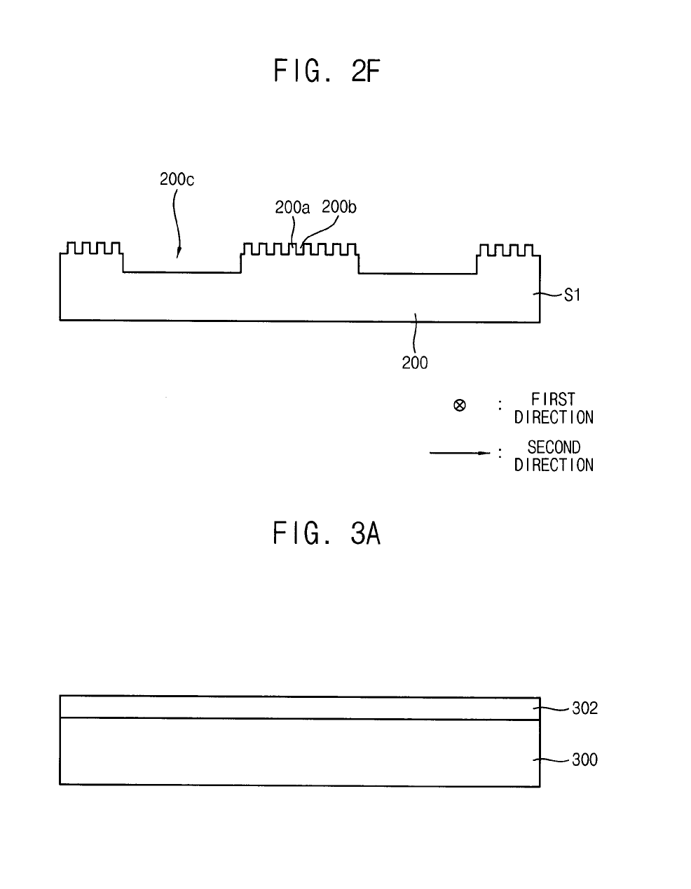

FIG. 2A to FIG. 2F are cross-sectional views for describing a method of manufacturing a mold for forming a polarizer of FIG. 1, according to one or more exemplary embodiments. The mold of one or more exemplary embodiments can decrease manufacturing costs of making a polarizer.

Referring to FIG. 2A, polymer layer 202 is formed on substrate 200. Polymer layer 202 may be a coating layer.

Substrate 200 includes a material which has relatively high transmittance, thermal stability, and chemical compatibility. For example, substrate 200 may include at least one material selected from the group of glass, quartz and metal, such as aluminum (Al), gold (Au), silver (Ag), copper (Cu), chrome (Cr), iron (Fe), or nickel (Ni).

Polymer layer 202 may include thermosetting resin or photo curable resin, but is not limited as such. For example, the thermosetting resin may include urea resin, melamine resin, phenol resin, etc. Further, the photo curable resin may include polymerizable compounds having a polymerizable functional group, a photo polymerization initiator initiating polymerization of the polymerizable compounds by irradiation, surfactants, antioxidants, etc.

Referring to FIG. 2B, substrate 200 on which polymer layer 202 is formed is patterned to form polymer pattern 204.

Polymer pattern 204 may be formed by a laser interference lithography process, a double patterning process, a spacer patterning process, an immersion lithography process, etc.

Polymer pattern 204 includes a plurality of protrusion portions 204a and a plurality of concave portions 204b.

Referring to FIG. 2C, substrate 200 is etched, using protrusion portions 204a of polymer pattern 204 as a cover mask. Polymer pattern 204 and substrate 200 may be dry-etched. After substrate 200 is etched, portions corresponding to protrusion portions 204a of polymer pattern 204 remain on substrate 200. Portions of polymer pattern 204 corresponding to concave portions 204b may be entirely removed to form a plurality of concave portions 200b in substrate 200. Thus, protrusion portions 204a of the polymer pattern 204 prevent an etching of substrate 200 where they are located, so as to form a plurality of protrusion portions 200a on the substrate 200. Portions of the substrate 200 corresponding to the concave portions 204b of the polymer pattern 204 are etched to form the concave portions 200b of the substrate 200. Thus, a wire grid template, including the plurality of the protrusion portions 200a and the plurality of the concave portions 200b, is formed on the substrate 200.

Referring to FIG. 2D, first mask 208 may be formed on substrate 200 (as shown in FIG. 2D after remaining portions (protrusion portions 204a) of polymer pattern 204 are removed, for example). First mask 208 may be formed on areas A corresponding to where protrusion portions of a first mold S1 are to be formed, referring to FIG. 2F.

First mask 208 may cover a portion of the wire grid template of substrate 200 disposed on the area A on which a protrusion portion of a first mold S1 to be formed. First mask 208 may be directly contacted with a surface of the wire grid template of the substrate 200. First mask 208 may include silicon oxide (SiOx), silicon nitride (SiNx), or silicon (Si). For example, first mask 208 may include silicon dioxide (SiO₂). First mask 208 may be formed by a photolithography process, an imprinting process, a printing process, an inkjet printing process, a chemical vapor deposition, etc.

Areas B in which first mask 208 is not formed may correspond to where recesses of a mold S1 are to be formed. First mask 208 can be arranged to not cover portions of the wire grid template of substrate 200 disposed on the areas B.

Referring to FIG. 2E, substrate 200 is etched. Recess 200c in substrate 200 is formed. Recess 200c is disposed to remove a portion of the wire grid pattern. Recess 200c may have a lower surface that is lower than a surface of the wire grid pattern. Processing substrate 200 can form recess 200c with a flat surface, by controlling etching conditions, for example. First mask 208 may prevent etching of substrate 200 disposed on areas A.

Referring to FIG. 2F, first mask 208 is removed from the substrate 200 to form first mold S1. First mold S1 may include the wire grid template including a plurality of the protrusion portions 200a and a plurality of the concave portions 200b. Protrusion portions 200a may be linear patterns extending in a first direction. The linear patterns may be spaced apart from each other in a second direction crossing the first direction.

Recess 200c of substrate 200 may be disposed between adjacent first masks. A distance between a lower surface of the substrate 200 and the lower surface of the recess 200c may be smaller than a distance between the lower surface of the substrate 200 and a surface of the wire grid template. A width of the recess 200c may be about 10 μm to about 100 μm.

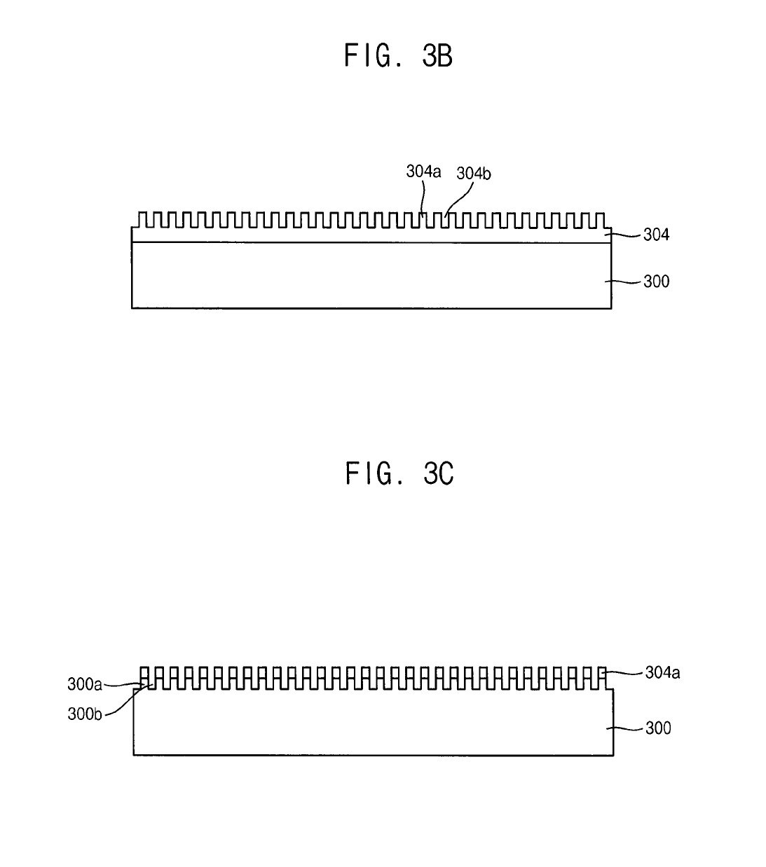

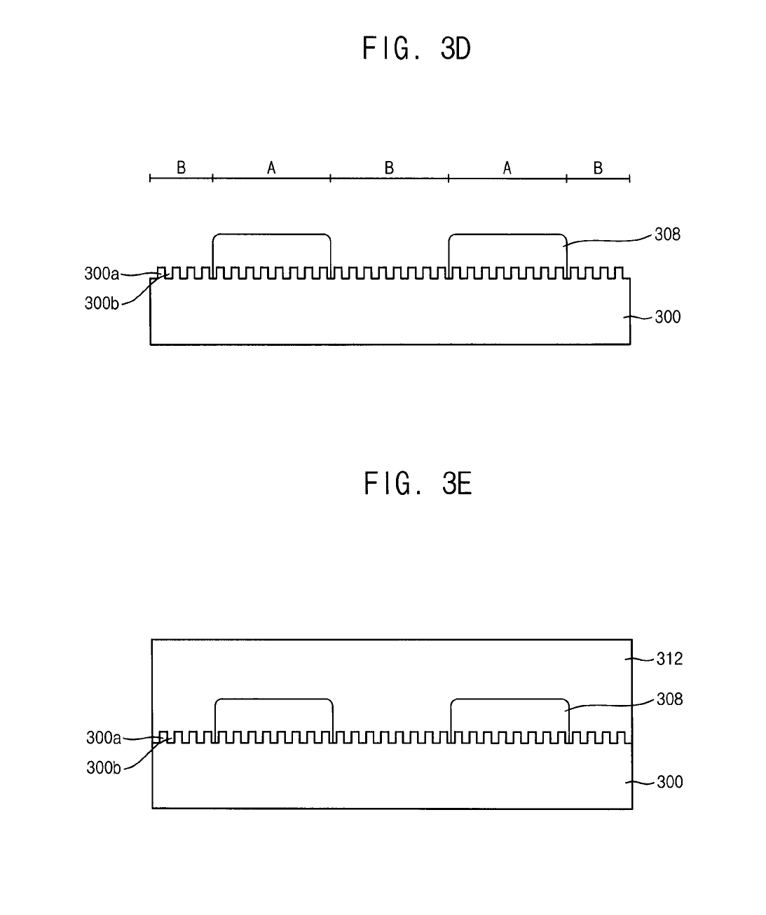

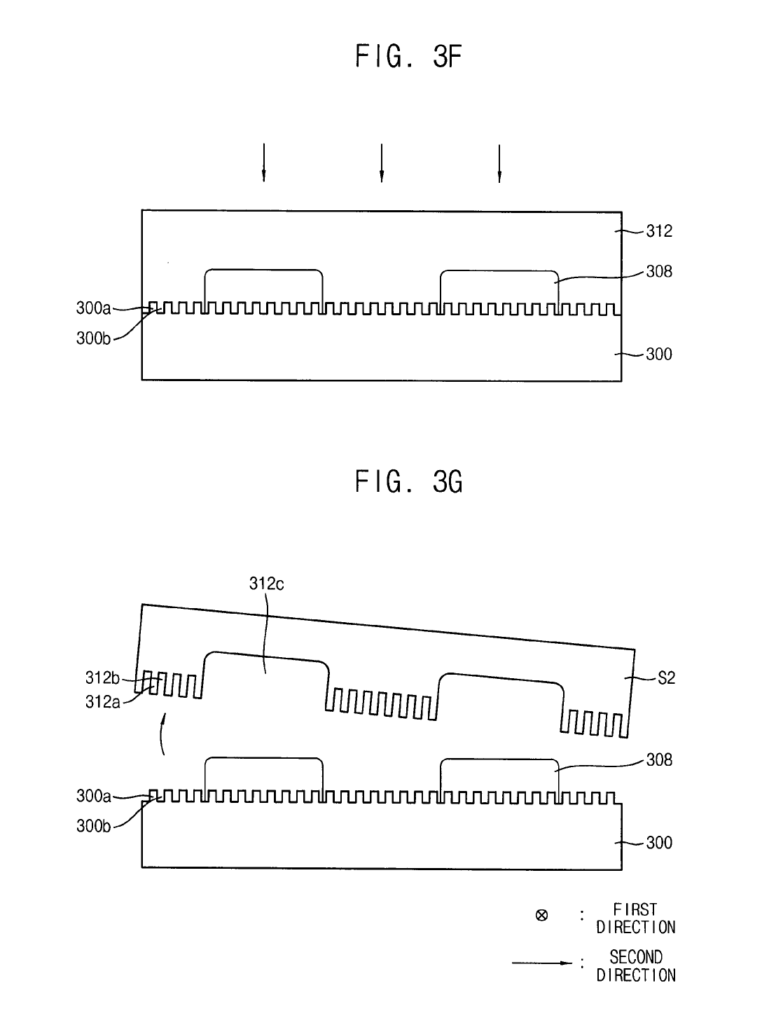

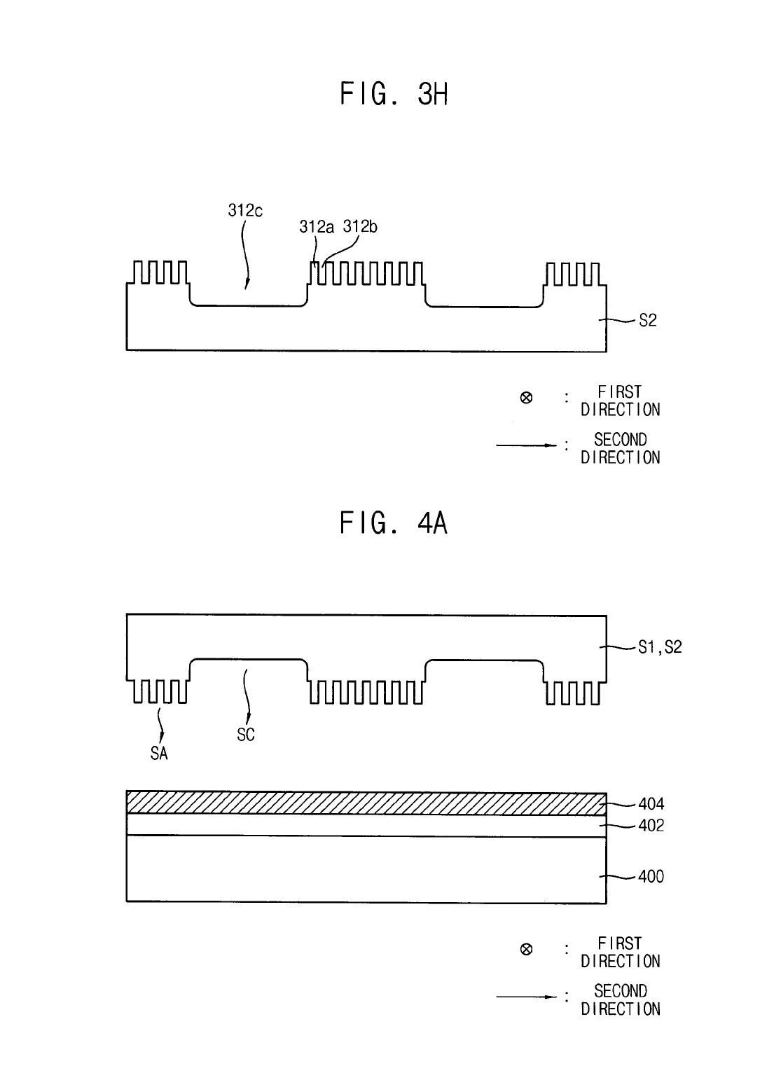

FIG. 3A to FIG. 3H are cross-sectional views for describing a method of manufacturing a mold for forming a polarizer of FIG. 1, according to one or more exemplary embodiments. In particular, a second mold S2 is formed for forming the polarizer of FIG. 1.

Referring to FIG. 3A, polymer layer 302 is formed on substrate 300. Polymer layer 302 may be a coating layer.

Substrate 300 includes material which has relatively high transmittance, thermal stability and chemical compatibility. For example, substrate 300 may include at least one material selected from the group of glass, polyethylenenaphthalate, polyethylene terephthalate, and polyacryl.

Polymer layer 302 may include thermosetting resin or photo curable resin, but is not limited as such. For example, the thermosetting resin may include urea resin, melamine resin, phenol resin, etc. The photo curable resin may include polymerizable compounds having a polymerizable functional group, a photo polymerization initiator initiating polymerization of the polymerizable compounds by irradiation, surfactants, antioxidants, etc.

Referring to FIG. 3B, polymer layer 302 is patterned to form a polymer pattern 304 on substrate 300.

Polymer pattern 304 may be formed by a laser interference lithography process, a double patterning process, a spacer patterning process, an immersion lithography process, etc.

Polymer pattern 304 includes a plurality of protrusion portions 304a and a plurality of concave portions 304b.

Referring to FIG. 3C, substrate 300 is etched using protrusion portions 304a of polymer pattern 304 as a cover mask. Polymer pattern 304 and substrate 300 may be dry-etched. After etching, protrusion portions 304a of the polymer pattern 304 remain on substrate 300 and a plurality of concave portions 300b in the substrate 300 correspond to concave portions 304b of polymer pattern 304. Thus, protrusion portions 304a of polymer pattern 304 prevent etching of substrate 300 where they are located so as to form a plurality of protrusion portions 300a on the substrate 300. Portions of substrate 300 corresponding to protrusion portions 304b of the polymer pattern 304 are etched to form concave portions 300b of substrate 300. Thus, a wire grid temple including a plurality of protrusion portions 300a and a plurality of the concave portions 300b is formed on the substrate 300.

Referring to FIG. 3D, second mask 308 may be disposed on substrate 300 (as shown in FIG. 3D after remaining portions (protrusion portions 304a) of polymer pattern 304 are removed, for example). Second mask 308 may be disposed on areas A corresponding to where recesses of second mold S2 are to be formed.

Second mask 308 may cover a portion of the wire grid template of substrate 300 disposed on areas A. Second mask 308 may directly contact a surface of the wire grid template of substrate 300. Second mask 308 may include silicon oxide (SiOx), silicon nitride (SiNx), or silicon (Si). For example, second mask 308 may include silicon dioxide (SiO₂). Second mask 308 may be formed by a photolithography process, an imprinting process, a printing process, an inkjet printing process, a chemical vapor deposition, etc.

Second mask 308 is not formed on areas B corresponding to where protrusion portions of mold S2 are to be formed. Second mask 308 does not cover portions of the wire grid template of substrate 300 disposed on areas B.

Referring to FIG. 3E, polymer layer 312 is disposed on substrate 300 and second mask 308. Polymer layer 312 may include thermosetting resin, photo curable resin or thermoplastic resin, but is not limited as such. For example, the thermosetting resin may include urea resin, melamine resin, phenol resin, etc. The photo curable resin may include polymerizable compounds having a polymerizable functional group, a photo polymerization initiator initiating polymerization of the polymerizable compounds by irradiation, surfactants, antioxidants, etc. The thermoplastic resin may include polyethylene, polypropylene, poly vinyl, polystyrene, acrylonitrile butadiene (ABS) resin, acrylic resin, but is not limited as such.

Referring to FIG. 3F, polymer layer 312 is disposed on substrate 300 and second mask 308. Pressure is applied on polymer layer 312 in a direction towards substrate 300 (e.g., as indicated by the downward arrows in FIG. 3F).

Substrate 300 may include a material that has relatively low coefficient of thermal expansion, such as metal, when polymer layer 312 includes a thermosetting resin. Substrate 300 may include a material that has relatively high light-transmittance and strength, such as a transparent macromolecule, when polymer layer 312 includes a photo curable resin.

When polymer layer 312 includes a thermosetting resin, substrate 300 may be placed in contact with polymer layer 312, and then polymer layer 312 may be heated to a temperature over a glass transition temperature of the thermosetting resin. When polymer layer 312 includes a thermoplastic resin, substrate 300 may be placed in contact with polymer layer 312, and then polymer layer 312 may be heated to a temperature over a glass transition temperature of the thermoplastic resin. After that process, polymer layer 312 may be pressed toward the substrate 300, so that the wire grid template including protrusion portions 300a and concave portions 300b and the pattern of second mask portions 308 are imprinted in polymer layer 312. Polymer layer 312 is cooled to a temperature under the glass transition temperature, so that patterned polymer layer 312 becomes rigid. Thus, a plurality of linear patterns including a plurality of protrusion portions 312a and a plurality of concave portions 312b may be formed, along with recess portions 312c.

When polymer layer 312 includes a photo curable resin, substrate 300 may be placed in contact with polymer layer 312, and then polymer layer 312 may be pressed toward the substrate 300, so that the wire grid template including protrusion portions 300a and concave portions 300b and the pattern of the second mask 308 are imprinted in polymer layer 312. Polymer layer 312 may include material which has high light-transmittance, so that polymer layer 312 may be irradiated by light to make the patterned polymer layer 312 rigid.

Referring to FIG. 3G and FIG. 3H, patterned polymer layer 312 is separated from substrate 300 to form second mold S2. Second mold S2 may include the wire grid template including the plurality of protrusion portions 312a and the plurality of concave portions 312b and recesses 312c. Protrusion portions 312a may be a plurality of linear patterns. Like the linear patterns of FIG. 2F, the linear patterns may extend in a first direction. Adjacent linear patterns may be spaced apart from each other in a second direction crossing the first direction.

Protrusion portions 312a of the wire grid template may have a shape opposite to concave portions 300b of substrate 300. Concave portion 312b of the wire grid pattern may have a shape opposite to protrusion portions 300a of substrate 300. Recess 312c may have a shape opposite to second mask portions 308. Recesses 312c may have a lower surface that is lower than a surface of linear patterns of protrusion portion 312a. Recess 312c may have a height different from the height of the wire grid template. As shown in FIG. 3H, a distance between a lower surface of the second mold S2 and the bottom surface of a recess 312c may be smaller than a distance between the lower surface of the second mold S2 and a surface of the wire grid pattern. A width of the recess 312c may be about 10 μm to about 100 μm.

In one or more exemplary embodiments, substrate 300 including the plurality of protrusion portions 300a and the plurality of the concave portions 300b which is used for forming the second mold S2 may be reused for other method of manufacturing a mold. Exemplary embodiments for the reuse will be described below.

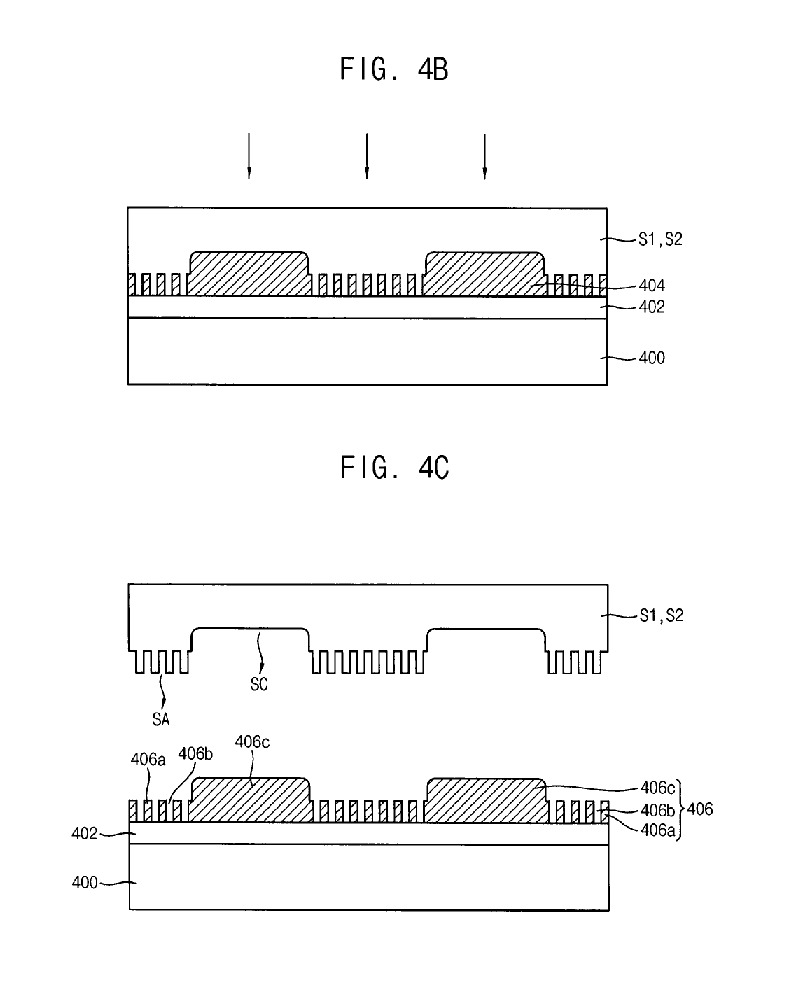

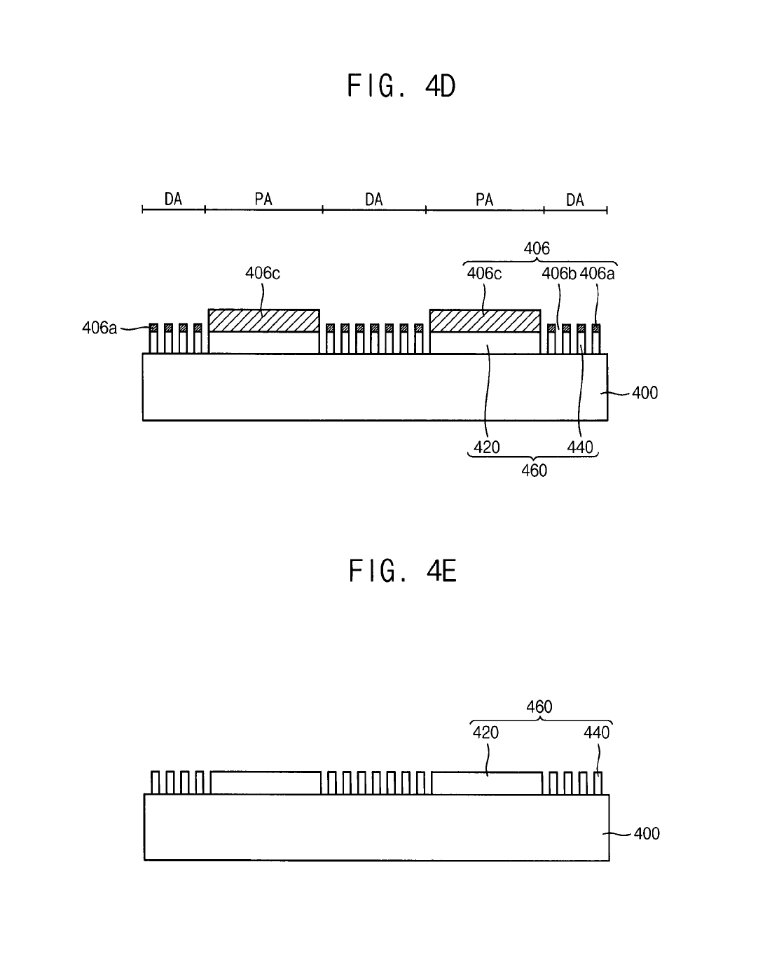

FIG. 4A to FIG. 4E are cross-sectional views for describing a method of manufacturing a polarizer of FIG. 1, according to one or more exemplary embodiments.

Referring to FIG. 4A, metal layer 402 may be disposed on substrate 400.

Substrate 400 may include a material which has relatively high transmittance, thermal stability, and chemical compatibility. For example, substrate 400 may include at least one material selected from the group of glass, polyethylenenaphthalate, polyethylene terephthalate, and polyacryl.

Metal layer 402 may include at least one material selected from the group of aluminum (Al), gold (Au), silver (Ag), copper (Cu), chrome (Cr), iron (Fe), and nickel (Ni). Metal layer 402 may be formed by a deposition process. For example, metal layer 402 may be formed by a chemical vapor deposition process. The thickness of metal layer 402 from the substrate 400 may be about 100 nm to about 200 nm.

Polymer layer 404 may be disposed on metal layer 402. Polymer layer 404 may include thermosetting resin or photo curable resin, but is not limited as such. For example, a thermosetting resin may include urea resin, melamine resin, phenol resin, etc. A photo curable resin may include polymerizable compounds having a polymerizable functional group, a photo polymerization initiator initiating polymerization of the polymerizable compounds by irradiation, surfactants, antioxidants, etc.

Mold S1 or mold S2 may be placed in contact with substrate 400. Mold S1 and mold S2, for example, correspond to the first mold S1 in FIG. 2F and the second mold S2 in FIG. 3H, respectively.

Mold S1 or mold S2 may include a wire grid templates SA and recesses SC. The wire grid templates SA may include a pattern opposite to a linear pattern of a polarizer. Recesses SC may include a pattern opposite to a reflection pattern of a polarizer, and may have a height different from the height of wire grid template SA. Recesses SC may have a bottom surface that is lower than a surface of the wire grid templates SA.

Referring to FIG. 4B and FIG. 4C, mold S1, S2 may be placed in contact with polymer layer 404, and mold S1, S2 may be pressed toward polymer layer 404 as indicated by the downward arrows, and thus transfer a pattern into polymer layer 404 disposed on metal layer 402.

Mold S1, S2 may include a material that has relatively low coefficient of thermal expansion, such as metal, when polymer layer 404 includes a thermosetting resin. Mold S1, S2 may include a material that has relatively high light-transmittance and strength, such as transparent macromolecule, when polymer layer 404 includes a photo curable resin.

Mold S1, S2 may be placed in contact polymer layer 404, and then polymer layer 404 may be heated to a temperature over a glass transition temperature of the thermosetting resin when polymer layer 404 includes a thermosetting resin. After that process, mold S1, S2 may be pressed toward polymer layer 404, so that the pattern of mold S1, S2 is imprinted in polymer layer 404. Then, polymer layer 404 may be cooled to a temperature under the glass transition temperature, so that the patterned polymer layer 404 becomes rigid and forms transferred pattern 406.

Mold S1, S2 may be set to contact polymer layer 404, and then mold S1, S2 may be pressed toward the polymer layer 404, so that the pattern of mold S1, S2 is imprinted in polymer layer 404 when polymer layer 404 includes a photo curable resin. Mold S1, S2 may include a material which has high light-transmittance, so that polymer layer 404 may then be irradiated by light and become rigid and form transferred pattern 406.

Referring to FIG. 4C, mold S1, S2 are removed. Transferred pattern 406, which has a shape opposite to mold S1, S2, is formed on metal layer 402.

Transferred pattern 406 includes grid portions 406a, concave portions 406b, and reflection portions 406c. Grid portions 406a and concave portions 406b may have a shape opposite to respective portions of wire grid template SA. Reflection portions 406c may have a flat surface and may have a shape opposite to recesses SC of mold S1, S2. As shown in FIG. 4C, a distance between a surface of metal layer 402 and the top surface of the reflection portion 406c may be greater than a distance between the surface of metal layer 402 and the top surface of grid portions 406a.

Referring to FIG. 4D, transferred pattern 406 and metal layer 402 may be dry-etched using grid portions 406a and reflection portions 406c of transferred pattern 406 as a cover mask for metal layer 402. Grid portion 406a prevents corresponding portions of metal layer 402 from being etched. As grid portions 406a and reflection portions 406c of transferred pattern 406 are etched, a portion of reflection portions 406c will remain after grid portions 406a are entirely etched away, due to the different height of grid portions 406a and reflection portions 406c.

Concave portions 406b of transferred pattern 406 and portions of metal layer 402 under concave portions 406b may be etched and removed. Grid portions 406a of transferred pattern 406 and portions of the metal layer 402 corresponding to concave patterns 406b may be patterned to form a plurality of linear patterns 440.

Reflection portions 406c of transferred pattern 406 may be used as a cover mask covering metal layer 402. Reflection portions 406c prevent portions of metal layer 402 corresponding to reflection portions 406c from being etched. Thus, reflection pattern 420 may be formed on a peripheral area PA on which an image is not displayed.

Reflecting pattern 420 may be located at substantially the same area as a black matrix, such as a black matrix illustrated in FIG. 6.

Referring to FIG. 4D and FIG. 4E, grid portions 406a and reflection portions 406c disposed on the reflection portions 420 and the linear pattern 440 are etched. A remaining portion of reflection portions 406c is removed. Thus, polarizer 460 may be formed. Polarizer 460 may be formed on substrate 400 such that reflection portion 420 and linear pattern 440 are formed substantially at the same time. More specifically, unlike other methods, reflection portions 420 can be formed by depositing a flat metal layer on a flat substrate, and the flatness of reflection portions and linear patterns 440 are maintained due to the etching process using the molds S1, S2, according to one or more embodiments. Thus, the surfaces of reflection portions 420 and linear patterns are flat relative to the substrate and relatively more flat in comparison with corresponding features formed by other methods. Since reflection portions 420 are not formed after e.g., patterning a linear pattern on the entire substrate and etching away linear patterns in locations corresponding to reflection portions, reflection portions 420 are not formed on a residue of etched away linear portions. Moreover, the enhanced flatness may enhance the reflection property. Polarizer 460 may include a plurality of linear patterns 440 and reflection portions 420. Linear pattern 440 and reflection portions 420 may be formed from metal layer 402. Adjacent linear patterns may be spaced apart from each other. Linear patterns 440 and the reflection portions 420 may be disposed on the same layer.

Polarizer 460 may include at least one material selected from the group of aluminum (Al), gold (Au), silver (Ag), copper (Cu), chrome (Cr), iron (Fe), and nickel (Ni).

Polarizer 460 may include a first sublayer and a second sublayer disposed on the first sublayer. The first sublayer may include at least one material selected from the group of aluminum (Al), gold (Au), silver (Ag), copper (Cu), chrome (Cr), iron (Fe), and nickel (Ni). The second sublayer may include molybdenum or titanium.

Polarizer 460 may include a plurality of linear patterns 440, through which light may pass, and reflection portion 420 on which blocks light.

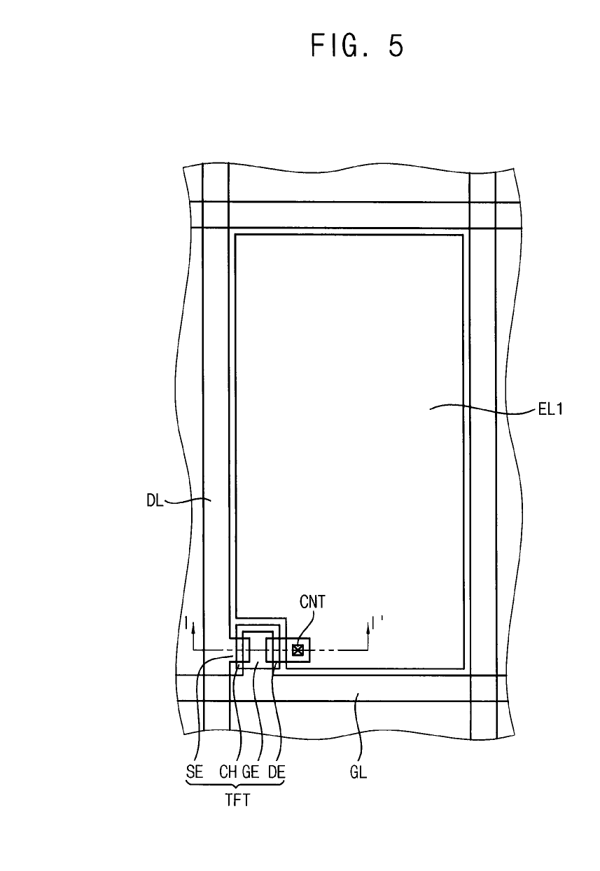

FIG. 5 is a cross-sectional view illustrating a display panel, according to one or more exemplary embodiments. FIG. 6 is a cross-sectional view taken along a line I-I′ of FIG. 5, according to one or more exemplary embodiments.

The display panel may include an array substrate, an opposing substrate and a liquid crystal layer LC between the array substrate and the opposing substrate.

The array substrate may include first substrate 500, metal layer 560, first insulation layer 550, gate insulation layer 570, thin film transistor TFT, protecting layer 580, and first electrode EL1.

First substrate 500 includes a material which has relatively high transmittance, thermal stability, and chemical compatibility. For example, first substrate 500 may include at least one material selected from the group of glass, polyethylenenaphthalate, polyethylene terephthalate, and polyacryl.

Metal layer 560 may be disposed on first substrate 500. Metal layer 560 includes a plurality of linear patterns 540 and reflection portion 520. The linear patterns 540 and reflection portion 520 may be disposed on the same layer. The linear patterns 540 may be formed on a display area DA on which an image is displayed. Reflection portion 520 may be formed on the peripheral area PA on which an image is not displayed and is adjacent to the display area DA. For example, reflection portion 520 may have a dimension substantially in common relative to a black matrix BM of a second substrate that will be described below.

Metal layer 560 may include at least one material selected from the group of aluminum (Al), gold (Au), silver (Ag), copper (Cu), chrome (Cr), iron (Fe), and nickel (Ni).

Metal layer 560 may include a first sublayer and a second sublayer disposed on the first sublayer. The first sublayer may include at least one material selected from the group of aluminum (Al), gold (Au), silver (Ag), copper (Cu), chrome (Cr), iron (Fe), and nickel (Ni). The second sublayer may include molybdenum or titanium.

The linear patterns 540 may be configured such that light passes through the gaps between the linear patterns 540. Adjacent linear patterns may be spaced apart from each other.

The linear pattern 540 may be configured such that each piece of the linear pattern 540 has a width L (e.g., the width L of FIG. 1), and adjacent two pieces of the linear patterns have a separation distance S (e.g., the separation distance S of FIG. 1) therebetween. A pitch P (e.g., the pitch P of FIG. 1) is the sum of the line width L and the separation distance S. Metal layer 560 may include an air gap between adjacent linear patterns 540.

The separation distance S may be smaller than a wavelength of incident light to polarize the incident light. For example, when the incident light is visible light, the wavelength of the incident light is about 400 nm to about 700 nm, so that the separation distance S is configured to be smaller than about 400 nm.

For example, the pitch P of the linear pattern 540 may be about 50 nm to about 100 nm. A height of the linear pattern 540 which is corresponding to a distance between an upper surface of the first substrate 500 and an upper surface of the linear pattern 540, may be about 50 nm to about 300 nm.

Reflection portion 520 may reflect light to improve light-efficiency of the display panel. Reflection portion 520 may correspond to location of a circuit pattern including thin film transistor TFT.

For example, the width of the reflection portion 520 may be about 10 μm to about 100 μm. The height of reflection portion 520 may be about 50 nm to about 300 nm.

Thus, light from a backlight unit (not shown), which may be disposed under the display panel of a display apparatus may partially pass through and may be polarized by linear patterns 540 in the display area DA, and may be partially reflected by reflection portions 520 toward the backlight unit such that light may be reflected by reflection portions 520 in the peripheral area PA toward the backlight unit. The reflected light travelling towards the backlight unit may be reflected again on a reflective plate (not shown) disposed under the backlight unit and may pass through linear patterns 540. Thus, light efficiency of the display apparatus may be increased.

First insulation layer 550 may be disposed on metal layer 560. First insulation layer 550 may include silicon oxide (SiOx).

A gate line GL and a gate electrode GE may be disposed on first insulation layer 550. The gate line GL and the gate electrode GE may be formed in the peripheral area PA. The gate electrode GE may be electrically connected to the gate line GL.

Gate insulation layer 570 may be disposed on first insulation layer 550 on which the gate electrode GE and the gate line GL may be disposed. Gate insulation layer 570 may include one or more inorganic materials, such as silicon oxide (SiOx) and/or silicon nitride (SiNx).

A channel layer CH may be disposed on gate insulation layer 570 to overlap the gate electrode GE.

The channel layer CH may include a semiconductor layer including amorphous silicon (a-Si:H) and an ohmic contact layer including n+ amorphous silicon (n+a-Si:H). For example, the channel layer CH may include an oxide semiconductor. For example, the oxide semiconductor may include an amorphous oxide including indium (In), zinc (Zn), gallium (Ga), tin (Sn), and/or hafnium (Hf). For example, the oxide semiconductor may include an amorphous oxide including indium (In), zinc (Zn), and/or gallium (Ga), or an amorphous oxide including indium (In), zinc (Zn) and/or hafnium (Hf). The oxide semiconductor may include an oxide, such as indium zinc oxide (InZnO), indium gallium oxide (InGaO), indium tin oxide (InSnO), zinc tin oxide (ZnSnO), gallium tin oxide (GaSnO), and/or gallium zinc oxide (GaZnO).

A data line DL crossing the gate line GL may be disposed on gate insulation layer 570.

A source electrode SE and a drain electrode DE may be disposed on the channel layer CH. The source electrode SE may be electrically connected to the data line DL, and may be spaced apart from the drain electrode DE. The drain electrode DE may be electrically connected to the first electrode EL1 through a contact hole CNT.

The gate electrode GE, the source electrode SE, the drain electrode DE and the channel layer CH may form the thin film transistor TFT in the peripheral area PA.

Protecting layer 580 may be disposed on the thin film transistor TFT. Protecting layer 580 may include one or more inorganic materials, such as silicon oxide (SiOx) and/or silicon nitride (SiNx). For example, protecting layer 580 may include an organic insulation material having relatively low permittivity. For example, protecting layer 580 may have a double layer structure of inorganic and organic insulating layers. Protecting layer 580 may include the contact hole CNT exposing a portion of the drain electrode DE.

The opposing substrate includes second substrate 600, black matrix BM, color filter CF, over-coating layer 610, second electrode EL2, and upper polarizer 620.

Second substrate 600 faces first substrate 500, with a liquid crystal layer LC between the substrates. Second substrate 600 may include a material which has relatively high transmittance, thermal stability, and chemical compatibility. For example, substrate 600 may include at least one material selected from the group of glass, polyethylenenaphthalate, polyethylene terephthalate, polyacryl, and a combination thereof

Black matrix BM may be disposed under second substrate 600. The black matrix BM may be disposed in the peripheral area PA, and the black matrix BM may block light. Thus, the black matrix BM may overlap the data line DL, the gate line GL, and the thin film transistor TFT within the peripheral area PA.

The color filter CF may be disposed in the display area DA and under second substrate 600 on which the black matrix BM may be formed. As shown in FIG. 6, the color filter CF may cover an edge portion of the black matrix BM, but exemplary embodiments are not limited as such. The color filter CF may not cover the black matrix BM. The color filter CF may selectively filter the light passing through the liquid crystal layer LC so that the light passes through the color filter CF has a designated color. The color filter CF may include, for example, a red color filter, a green color filter or a blue color filter. The color filter CF may correspond to a pixel area. Color filters adjacent to each other may have different colors. The color filter CF may be overlapped with an adjacent color filter CF in a boundary of the pixel area. For example, the color filter CF may be spaced apart from the adjacent color filter CF in the boundary of the pixel area.

Over-coating layer 610 may be disposed under the color filter CF and the black matrix BM. Over-coating layer 610 may flatten the color filter CF, protect the color filter CF, and insulate the color filter CF. Over-coating layer 610 may include e.g., an acrylic-epoxy material.

The second electrode EL2 may be disposed under over-coating layer 610. The second electrode EL2 may correspond to both the display area DA and the peripheral area PA. The second electrode EL2 may correspond to the display area DA and not to the peripheral area PA, according to one or more exemplary embodiments. The second electrode EL2 may include a transparent conductive material, such as indium tin oxide (ITO), indium zinc oxide (IZO), etc.

Upper polarizer 620 may be disposed on second substrate 600. Upper polarizer 620 may be an absorbing polarizer.

The liquid crystal layer LC may be disposed between the first substrate and the second substrate. The liquid crystal layer LC may include liquid crystal molecules having optical anisotropy. The liquid crystal molecules may be driven by an electric field, so that an image is displayed by passing light through or blocking light from passing through liquid crystal layer LC.

According to one or more exemplary embodiments, a reflection portion of the polarizer including flat surface may partially reflect light.

According to one or more exemplary embodiments, the polarizer includes a pattern which corresponds to a black matrix disposed in a peripheral area. The peripheral area is an area on which an image is not displayed. Thus, light efficiency from the backlight unit may be improved.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A method of manufacturing a mold, the method comprising:
forming a polymer pattern on a substrate, the polymer pattern comprising protrusions;
forming a wire grid template portion on the substrate by etching, the substrate being etched using protrusions of the polymer pattern as a mask;
forming a cover mask covering a portion of the wire grid template portion;
forming a recess in the substrate by etching, the substrate being etched using the cover mask, the recess having a bottom surface lower than an upper surface of the wire grid template portion; and
removing the cover mask.

2. The method of claim 1, wherein a pitch of the wire grid template portion is about 50 nm to about 100 nm and a height of the wire grid template portion is about 50 nm to about 300 nm, the wire grid template portion corresponding to a wire-grid polarizer of an apparatus to be manufactured by the mold.

3. The method of claim 1, wherein a width of the recess is about 10 μm to about 100 μm, the recess corresponding to a reflector portion for a black matrix of an apparatus to be manufactured by the mold.

4. The method of claim 1, wherein the substrate comprises at least one of glass, quartz, and metal.

5. The method of claim 1, wherein the wire grid template portion comprises linear patterns extending in a first direction, and
wherein the linear patterns are spaced apart from each other in a second direction.

6. The method of claim 1, wherein forming the recess removes part of the wire grid template portion.

7. The method of claim 1, wherein forming the polymer pattern comprises:
forming a coating layer by coating thermosetting resin or photo curable resin on the substrate; and
curing the coating layer.

8. The method of claim 7, wherein the coating layer is cured by heat or ultraviolet rays based on the type of coating layer.

9. A method of manufacturing a mold, the method comprising:
forming a polymer pattern on a substrate, the polymer pattern comprising protrusions;
forming a wire grid template portion on the substrate by etching the substrate, the substrate being etched by using the protrusions of the polymer pattern as a mask;
forming a cover mask covering a portion of the wire grid template portion;
forming a polymer layer on exposed portions of the wire grid template portion and the cover mask;
applying pressure on the polymer layer; and
separating the polymer layer from the substrate, the separated polymer layer comprising a recess portion and a linear pattern portion,
wherein the recess portion has a bottom surface lower than an upper surface of the linear pattern portion,
wherein the recess portion is formed corresponding to the cover mask, and
wherein the linear pattern portion is formed corresponding to the exposed portions of the wire grid template portion.

10. The method of claim 9, wherein the linear pattern portion is formed to extend to a first direction and is spaced apart from another linear pattern portion in a second direction.

11. The method of claim 9, wherein a pitch of the linear pattern portion is about 50 nm to about 100 nm and a height of the linear pattern portion is about 50 nm to about 300 nm, the linear pattern portion corresponding to a gap of a wire-grid polarizer of an apparatus to be manufactured by the mold.

12. The method of claim 9, wherein a width of the recess portion is about 10 μm to about 100 μm.

13. The method of claim 9, wherein the polymer layer comprises at least one of urea resin, melamine resin, phenolic resin, epoxy resin, polyethylene, polypropylene, polyvinyl acetate, polystyrene, acrylo nitrile butadiene rubber, and acrylic resin.

14. The method of claim 9, wherein the substrate comprises at least one of polyethylenenapthalate, polyethyleneterephthalate, and poly-acryl.

15. A method of manufacturing a polarizer and a reflection portion, comprising:
disposing a metal layer on a substrate;
disposing a polymer layer on the metal layer;
forming a transferred pattern on the polymer layer based on a mold, the transferred pattern comprising a grid portion and a reflection portion, the grid portion comprising protrusion portions, the reflection portion having a width greater than a width of a protrusion portion; and
forming linear patterns and a reflection portion by etching the metal layer, the metal layer being etched using the transferred pattern as a mask, the linear patterns and the reflection portion being disposed on a same layer.

16. The method of claim 15, wherein the metal layer comprises at least one of aluminum (Al), gold (Au), silver (Ag), copper (Cu), chrome (Cr), iron (Fe), and nickel (Ni).

17. The method of claim 15, wherein portions of the metal layer not corresponding to the protrusion portions of the transferred pattern are exposed to be etched.

18. The method of claim 15, wherein portions of the metal layer corresponding to the protrusion portions of the transferred pattern form the linear patterns.

19. The method of claim 15, wherein a portion of the metal layer corresponding to the reflection portion of the transferred pattern forms the reflection portion.

20. The method of claim 15, wherein the transferred pattern is cured by heat or ultraviolet rays based on the type of polymer layer.
